(19) United States
(12) Patent Application Publication
(10) Pub. No.: US 2007/0075283 A1
(43) Pub. Date: Apr. 5, 2007

(54) Valve apparatus

(75) Inventors: Akinori Hirano, Nagoya-city (JP); Hiroo Tsujimoto, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Aichi-pref. (JP)

(21) Appl. No.: 11/540,686

(22) Filed: Oct. 2, 2006

(30) Foreign Application Priority Data
Oct. 4, 2005 (JP) 2005-291316

(51) Int. Cl. F16K 31/00

(52) U.S. Cl. 251/11

(57) ABSTRACT

A valve apparatus includes a valve body, a seat member, an oil supply port, a movable valve, and a pilot communicating member. The seat member is fixed to the valve body and defines a bleed chamber. The oil supply port supplies oil to the bleed chamber. The movable valve is slidably received in the valve body, wherein the movable valve is displaceable based on a pressure in the bleed chamber, and the movable valve blockades the oil supply port in a state, where the movable valve contacts the seat member. The pilot communicating member provides communication between the oil supply port and the bleed chamber in the state, where the movable valve contacts the seat member. The pilot communicating member includes a slight clearance changing member that increases a degree of the communication when a temperature decreases, and decreases the degree of the communication when the temperature increases.

### CROSS REFERENCE TO RELATED APPLICATION

This application is based on and incorporates herein by reference Japanese Patent Application No. 2005-291316 filed on Oct. 4, 2005.

### BACKGROUND OF THE INVENTION

1. Field of the Invention

The present invention relates to a valve apparatus, in which a movable valve is driven by a pressure of oil in a bleed chamber.

2. Description of Related Art

Japanese Unexamined Patent Publication No. 2002-357281 corresponding to U.S. Pat. No. 6,615,869 discloses a solenoid oil pressure control valve serving as a valve apparatus, wherein a movable valve is driven by a pressure of oil in a bleed chamber.

The solenoid oil pressure control valve disclosed in Japanese Unexamined Patent Publication No. 2002-357281 will be described with reference to FIGS. 4, 5. Similar components of the solenoid oil pressure control valve, which are similar to components of a solenoid oil pressure control valve of a preferred embodiment, will be indicated by the same numerals.

The solenoid oil pressure control valve includes a bleed chamber 34, a spool return spring 5, a solenoid bleed valve 2, and a spool valve 1 having a spool 4 (a movable valve). The spool 4 of the spool valve 1, which has a three-way-valve structure, is driven in a longitudinal direction by a pressure in the bleed chamber 34. The spool returning spring 5 spring biases the spool 4 in one of slide movement directions (rightward in FIG. 4), and the solenoid bleed valve 2 controls the pressure in the bleed chamber 34.

The solenoid bleed valve 2 forms the bleed chamber 34 between the solenoid bleed valve 2 and the spool 4, and compressed oil is supplied into the bleed chamber 34. The solenoid bleed valve 2 further includes a seat member 31, an open and close valve 32 and a solenoid actuator 33. The seat member 31 includes a bleed port 35, which provides communication between the bleed chamber 34 and a low pressure portion. The solenoid actuator 33 drives the open and close valve 32, which opens and closes the bleed port 35. When the spool 4 contacts (is seated with) the seat member 31, an oil supply port 12, through which the oil is supplied into the bleed chamber 34, is blockaded. Also, when the spool 4 is disengaged from the seat member 31, the oil supply port 12 is opened.

The seat member 31 includes a cylindrical portion 61 and an annular seat 62. The cylindrical portion 61 internally includes the bleed chamber 34, and the annular seat 62 is provided at an end face of the cylindrical portion 61 and contacts the spool 4 at all around the annular seat 62.

When the spool 4 contacts the annular seat 62, the oil supply port 12 is blockaded by the spool 4 as described above.

When the spool 4 contacts the annular seat 62 and the oil supply port 12 is “completely blockaded” by the spool 4, it may become difficult to supply oil into the bleed chamber 34 specially at a low temperature state, where the oil has a large viscosity.

Thus, in a conventional art, an orifice 64 (a small slit formed in the annular seat 62 and depicted as a pilot communicating portion 63) is formed at a part of the annular seat 62 to connect the oil supply port 12 and the bleed chamber 34. Therefore, even when the spool 4 is engaged with (contact) the annular seat 62, the oil supply port 12 is communicated with the bleed chamber 34 through the orifice 64.

Oil has a larger viscosity at a lower temperature state and a smaller viscosity at a higher temperature state.

Due to this property, when a passage area (cross-sectional area) of the orifice 64 is smaller at the low temperature state, a flow rate of the oil supplied to the bleed chamber 34 through the orifice 64 may become smaller. Thus, a responsibility of the spool 4 at a time, where the bleed port 35 is closed, may be degraded. In contrast, when the passage area of the orifice 64 is larger at the high temperature state, the flow rate of the oil supplied to the bleed chamber 34 through the orifice 64 may become larger. Thus, a consumption flow rate of the oil at a time, where the spool 4 is engaged with the seat member 31, may become larger than needed.

### SUMMARY OF THE INVENTION

The present invention is made in view of the above disadvantages. Thus, it is an objective of the present invention to address at least one of the above disadvantages.

To achieve the objective of the present invention, there is provided a valve apparatus, which includes a valve body, a seat member, an oil supply port, a movable valve, and a pilot communicating member. The seat member is fixed to the valve body and defines a bleed chamber. The oil supply port supplies oil to the bleed chamber. The movable valve is slidably received in the valve body, wherein the movable valve is displaceable based on a pressure in the bleed chamber, and the movable valve blockades the oil supply port in a state, where the movable valve contacts the seat member. The pilot communicating member provides communication between the oil supply port and the bleed chamber in the state, where the movable valve contacts the seat member. The pilot communicating member includes a slight clearance changing member that increases a degree of the communication when a temperature decreases, and decreases the degree of the communication when the temperature increases.

### BRIEF DESCRIPTION OF THE DRAWINGS

The invention, together with additional objectives, features and advantages thereof, will be best understood from the following description, the appended claims and the accompanying drawings in which:

FIG. 1A is a sectional view taken along a longitudinal line of a solenoid oil pressure control valve at a low temperature state according to a preferred embodiment of the present invention;

FIG. 1B is a sectional view taken along the longitudinal line of the solenoid oil pressure control valve at a high temperature state according to the preferred embodiment of the present invention;

FIG. 2A is a sectional view of a seat member at the low temperature state viewed along the longitudinal line according to the preferred embodiment of the present invention;

FIG. 2B is a schematic view taken along line IIB-IIB in FIG. 2A;

FIG. 2C is a sectional view of the seat member at the high temperature state viewed along the longitudinal line according to the preferred embodiment of the present invention;

FIG. 2D is a schematic view taken along line IID-IID in FIG. 2C;

FIG. 3 is a diagram showing a relation between an electric current supplied to a solenoid actuator and a consumption flow rate of oil at a solenoid bleed valve;

FIG. 4 is a sectional view of a conventional solenoid oil pressure control valve taken along a longitudinal line of the valve;

FIG. 5A is a sectional view of a seat member viewed along the longitudinal line according to the conventional solenoid oil pressure control valve; and

FIG. 5B is a schematic view taken along line VB-VB in FIG. 5A.

### DETAILED DESCRIPTION OF PREFERRED EMBODIMENTS

The preferred embodiment, in which a valve apparatus of the present invention is applied to a solenoid oil pressure control valve, will be described. Firstly, a basic structure of the solenoid oil pressure control valve will be described, and then characteristics of the preferred embodiment will be described.

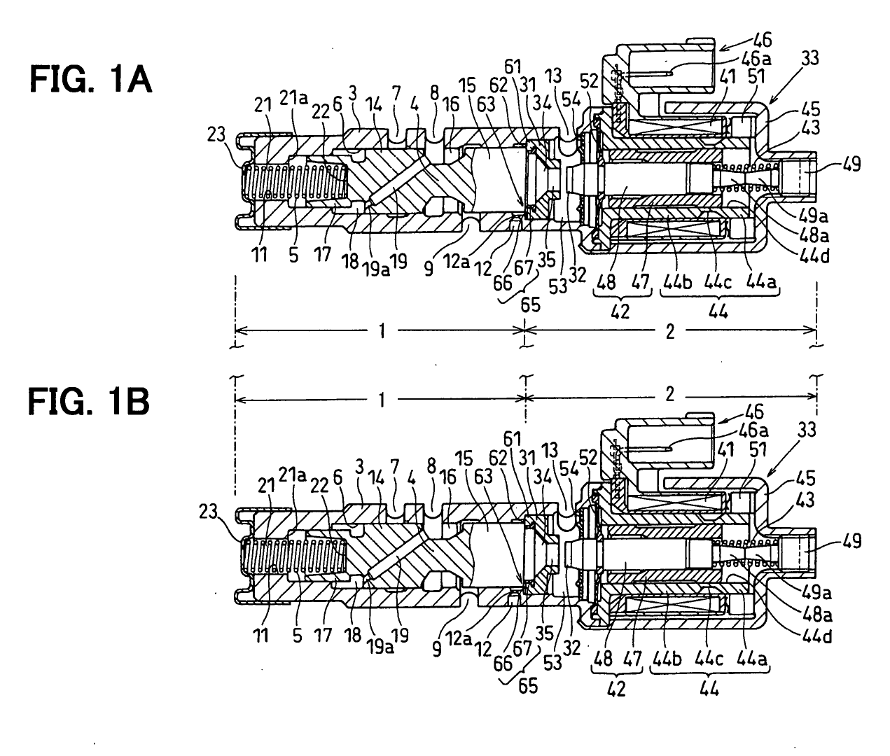

The solenoid oil pressure control valve shown in FIG. 1 is, for example, mounted on an oil pressure control apparatus for an automatic transmission, and includes a spool valve (main valve) 1 and a solenoid bleed valve (electrically driven bleed valve) 2. The spool valve 1 is structured as an oil pressure control valve for switching oil pressures or adjusting the oil pressure. The solenoid bleed valve 2 drives the spool valve 1. In the preferred embodiment, the solenoid oil pressure control valve is a normally open (N/O) valve. Thus, in a state where a solenoid actuator 33 is turned off, a degree of communication between the input port 7 and the output port 8 becomes maximum, and at the same time a degree of communication between the output port 8 and the drain port 9 becomes minimum (closed). Here, the solenoid actuator 33 constitutes the solenoid bleed valve 2.

The spool valve 1 includes a sleeve (valve body) 3, a spool (movable valve) 4, and a spool returning spring (compression coil spring) 5.

The sleeve 3 is received in a casing of an oil pressure controller (not shown), and has a generally cylindrical shape.

The sleeve 3 includes an insertion hole 6, the input port 7, the output port 8, and the drain port 9. The insertion hole 6 slidably supports the spool 4 slidable in a longitudinal direction of the spool 4. The input port 7 communicates with an oil discharge port of an oil pump (oil pressure generating means), and the input port 7 is supplied with input oil. Output oil, a pressure of which is adjusted by the spool valve 1, is outputted through the output port 8. The drain port 9 communicates with a low pressure portion (e.g., an oil pan).

A spring insertion hole 11, which receives the spool returning spring 5, is formed at a left end portion of the sleeve 3 in FIGS. 1A, 1B.

Oil ports, such as the input port 7, the output port 8, the drain port 9, are holes formed at a side face of the sleeve 3. The sleeve 3 includes the input port 7, the output port 8, the drain port 9, an oil supply port 12, and a bleed drain port 13 at the side face of the sleeve 3 in this order from left to right in FIGS. 1A, 1B. Here, the oil is supplied into the bleed chamber through the oil supply port 12, and the oil discharged from the bleed chamber 34 is discharged out of the sleeve 3 through the bleed drain port 13.

The oil supply port 12 includes a control orifice 12a for controlling a maximum flow rate of the oil, which passes through the oil supply port 12 such that a consumption flow rate of the oil in a state, where an open and close valve 32 is opened, can be reduced.

It is noted that the input port 7 communicates with the oil supply port 12 through a pressure-reducing valve outside the sleeve 3 (inside the oil pressure controller). The drain port 9 communicates with the bleed drain port 13 outside the sleeve 3 (inside the oil pressure controller).

The spool 4 is slidably displaceably received in the sleeve 3, and includes an input sealing land 14, which seals the input port 7, and a drain sealing land 15, which seals the drain port 9. A distribution chamber 16 is formed between the input sealing land 14 and the drain sealing land 15.

Also, the spool 4 includes a feed back (F/B) land 17 at a left side of the input sealing land 14 in FIGS. 1A, 1B. The F/B land 17 has a diameter smaller than that of the input sealing land 14. A feed back (F/B) chamber 18 is formed based on a difference of the lands (difference of the diameters) between the input sealing land 14 and the F/B land 17.

A feed back (F/B) port 19 is formed inside the spool 4 to provide communication between the distribution chamber 16 and the F/B chamber 18 such that a feed back (F/B) oil pressure can be generated based on an output pressure. The F/B port 19 includes a feed back (F/B) orifice 19a such that the appropriate F/B oil pressure can be generated inside the F/B chamber 18.

Therefore, as the oil pressure (output pressure) applied to the F/B chamber 18 is increased, an axial force, which displaces the spool 4 in a right direction in FIGS. 1A, 1B, is generated by the pressure difference due to the difference of the lands between the input sealing land 14 and the F/B land 17. Therefore, the displacement of the spool 4 can be stabilized, and as a result, a change of the output pressure due to a change of an input pressure can be limited.

It is noted that the spool 4 stops at a position, at which a spring load of the spool returning spring 5, a drive force of the spool 4 due to the pressure in the bleed chamber 34, and the axial force by the difference of the lands between the input sealing land 14 and the F/B land 17 are balanced.

The spool returning spring (coil spring) 5 spring biases the spool 4 toward a valve closed position (a position, at which the output pressure is decreased because an input sealing length becomes larger). In other words, the spool returning spring 5 biases the spool 4 rightward in FIGS. 1A, 1B in the present embodiment. Also, the spool returning spring 5 has a cylindrical spiral shape, and is compressed and provided at a spring chamber 21, which is located at a left side of the sleeve 3 in FIGS. 1A, 1B. The spool returning spring 5 contacts a bottom surface of a recess portion 22 formed inside of the F/B land 17 through one end of the spool returning spring 5. Also, the spool returning spring 5 contacts a bottom surface of a spring seat 23 through another end of the spool returning spring 5, the spring seat 23 being fixed to a left end portion of the sleeve 3 in FIGS. 1A, 1B by welding or crimping.

Here, a step face 21a formed inside the spring chamber 21, and “a maximum valve open position” of the spool 4 (spool maximum lift position) can be determined in a state, where the step face 21a contacts a left end portion of the spool 4 in FIGS. 1A, 1B.

The solenoid bleed valve 2 will be described. The solenoid bleed valve 2 displaces the spool 4 leftward in FIGS. 1A, 1B using the pressure in the bleed chamber 34 formed at the right side of the spool 4 in FIGS. 1A, 1B. The solenoid bleed valve 2 includes the seat member 31, the open and close valve 32 and the solenoid actuator 33.

The seat member 31 has a generally annular shape and is fixed inside a right side portion of the sleeve 3 in FIGS. 1A, 1B. The bleed chamber 34, which drives the spool 4, is formed between the seat member 31 and the spool 4. At a center portion of the seat member 31, there is formed the bleed port 35, which provides communication between the bleed chamber 34 and the low pressure portion (the above bleed drain port 13).

“A maximum valve closed position” of the spool 4 (spool seated position) is determined in a state, where a left end face of the seat member 31 in FIGS. 1A, 1B contacts the spool 4. Also, the right end face of the seat member 31 in FIGS. 1A, 1B contacts the open and close valve 32, which is provided at an end portion of a shaft 48. When the open and close valve 32 contacts the right end face of the seat member 31, the bleed port 35 is blockaded.

The solenoid actuator 33 includes a coil 41, a movable body 42, a moving body returning spring (compression coil spring) 43, a stator 44, a yoke 45, and a connector 46. The solenoid actuator 33 drives the open and close valve 32 to control an opening degree of the bleed port 35. When the open and close valve 32 reduces the opening degree of the bleed port 35, an internal pressure in the bleed chamber 34 increases to displace the spool 4 toward the valve open position (leftward in FIGS.1A, 1B). In contrast, when the open and close valve 32 increases the opening degree of the bleed port 35, the internal pressure in the bleed chamber 34 decreases to displace the spool 4 toward the valve closed position (rightward in FIGS. 1A, 1B).

The coil 41 generates a magnetic force when energized such that a magnetic flux loop is formed to go through the movable body 42 and the magnetic fixed body (the stator 44 and the yoke 45). Here, the coil 41 is formed by winding a dielectric coated wire about a resin bobbin in multiple times.

The movable body 42 includes a moving core 47 and the shaft 48.

The moving core 47 is made of a magnetic metal, and has a generally cylindrical shape. Also, the moving core 47 is slidable directly on an inner peripheral surface of the stator 44. Here, the magnetic metal includes, for example, iron, which is a ferromagnetic material for constituting a magnetic circuit.

The shaft 48 is made of a highly strong non-magnetic material, and has a generally cylindrical shape. Also, the shaft 48 is press fitted inside the moving core 47. The open and close valve 32 is formed at a left end portion of the shaft 48 in FIGS. 1A, 1B. Here, the non-magnetic material includes, for example, stainless steel.

The movable body returning spring (coil spring) 43 spring biases the shaft 48 toward the valve closed position (a position, at which the open and close valve 32 closes the bleed port 35). Also, the movable body returning spring 43 has a cylindrical spiral shape, and is compressed and provided between a right end portion of the shaft 48 in FIGS. 1A, 1B and an adjustor (adjusting screw) 49. Here, the adjustor 49 is screwed to a center portion of the yoke 45. The movable body returning spring 43 presses the open and close valve 32 to the seat member 31 (specifically, to the periphery of the bleed port 35) against the oil discharge pressure, which is applied to the open and close valve 32 through the bleed port 35, when the solenoid actuator 33 is turned off (i.e., when the solenoid actuator 33 does not generate a force, which otherwise displaces the shaft 48 rightward in FIGS. 1A, 1B). As a result, the bleed port 35 is closed. Here, a spring load of the movable returning spring can be adjusted based on a screw amount (threaded-into amount) of the adjustor 49.

Here, a shaft end projection portion 48a is formed at a right end portion of the shaft 48 in FIGS. 1A, 1B such that the shaft end projection portion 48a extends rightward inside the movable body returning spring 43 in FIGS. 1A, 1B. Also, an adjustor end projection portion 49a is formed at a left end portion of the adjustor 49 in FIGS. 1A, 1B such that the adjustor end projection portion 49a extends leftward inside the movable body returning spring 43 in FIGS. 1A, 1B. The shaft end projection portion 48a contacts the adjustor end projection portion 49a when the shaft 48 is displaced rightward in FIGS. 1A, 1B such that a maximum lift of the open and close valve 32 is determined.

The stator 44 is made of the magnetic metal (e.g., iron) and includes an attraction stator 44a, a slide stator 44b, and a magnetic saturation groove (field or portion, at which a magnetic resistance is large) 44c. The attraction stator 44a magnetically attracts the moving core 47 in a longitudinal direction (right side in FIGS. 1A, 1B). The slide stator 44b covers a periphery of the moving core 47 and delivers and receives the magnetic flux with the moving core 47 in a radial direction. The magnetic saturation groove 44c reduces an amount of the magnetic flux, which travels through a portion between the attraction stator 44a and the slide stator 44b, such that the magnetic flux travels from the slide stator 44b to the attraction stator 44a through the moving core 47.

At an inner periphery of the stator 44, there is formed a longitudinal hole 44d, which supports the moving core 47 such that the moving core 47 is slidable in the longitudinal direction. The longitudinal hole 44d is a through hole, which has the same diameter from one end to another end of the stator 44.

At an outer periphery of the attraction stator 44a, there is provided a magnetic delivering ring 51, which is made of the magnetic metal (e.g., iron) and is magnetically connected with the attractive stator 44a and the yoke 45. A magnetic force generated by the coil 41 magnetically attracts the moving core 47 toward the valve open position, at which the open and close valve 32 opens the bleed port 35. The attraction stator 44a includes a tubular portion, which longitudinally overlaps with the moving core 47 when the moving core 47 is magnetically attracted. An outer peripheral surface of the tubular portion is tapered such that the magnetic attractive force does not change relative to a stroke amount of the moving core 47.

The slide stator 44b covers a generally total circumference of the moving core 47 and has a generally cylindrical shape. The slide stator 44b is magnetically connected with the yoke 45 through a flange, which is held between the yoke 45 and the sleeve 3 in the longitudinal direction. The slide stator 44b is slidable directly on the moving core 47 and slidably supports the moving core 47 slidable in the longitudinal direction. Also, the slide stator 44b delivers and receives the magnetic flux with the moving core 47 in the radial direction.

The yoke 45 is made of the magnetic metal (e.g., iron) and has a tubular shape with a bottom for covering the periphery of the coil 41 and providing the magnetic flux. A nail portion formed at an opening end portion of the yoke 45 is crimped such that the yoke 45 is reliably fixed to the sleeve 3.

At a connection portion between the sleeve 3 and the yoke 45, there is provided a diaphragm 52, which divides (sections) the connection portion into a section inside the sleeve 3 and a section inside the solenoid actuator 33. The diaphragm 52 is made of a rubber, and has a generally annular shape. An outer peripheral portion of the diaphragm 52 is held between the sleeve 3 and the stator 44, and a center portion of the diaphragm 52 is engaged (fitted) with a groove, which is formed at an outer periphery of the shaft 48. Thus, the oil or objects are limited from entering into the solenoid actuator 33.

Here, the seat member 31 and the diaphragm 52 define a right side internal portion of the sleeve 3 to form an exhaust pressure chamber 53, which communicates with the bleed drain port 13. A pressure protecting masking shield 54 has a generally annular shape and is provided at one side of the diaphragm 52, the one side facing the exhaust pressure chamber 53. The pressure protecting masking shield 54 limits the pressure in the exhaust pressure chamber 53 from directly applying to the diaphragm 52.

The connector 46 electrically connects with an electronic control apparatus (not shown), which controls the solenoid oil pressure control valve, through a connection wire. Terminals 46a, each of which connects with a corresponding end of the coil 41, are provided inside the connector 46.

The electronic control apparatus controls an energizing amount (current value), which is supplied to the coil 41 of the solenoid actuator 33, based on a duty ratio control. Thus, by controlling the energizing amount to the coil 41, the electronic control apparatus linearly changes a longitudinal position of the movable body 42 against the spring load of the movable body returning spring 43. As a result, the electronic control apparatus controls the pressure generated in the bleed chamber 34 by changing the lift of the open and close valve 32 formed at the end portion of the shaft 48.

In this way, the electronic control apparatus controls the pressure generated in the bleed chamber 34 such that the longitudinal position of the spool 4 can be controlled. Thus, a ratio of the input sealing length to a drain sealing length can be controlled so that the output pressure of the oil at the output port 8 can be controlled. Here, the input sealing length is formed by the input sealing land 14 for the input port 7 and the distribution chamber 16. Also, the drain sealing length is formed by the drain sealing land 15 for the distribution chamber 16 and the drain port 9.

A specific operation of the solenoid oil pressure control valve will be described.

In a state where the solenoid actuator 33 is deenergized, the open and close valve 32 provided at the shaft 48 is seated with (engaged with) the seat member 31 to blockade the bleed port 35. As a result, the internal pressure in the bleed chamber 34 is increased due to the pressure of the oil, which is supplied to the bleed chamber 34 through the oil supply port 12. Thus, the spool 4 is displaced leftward in FIGS. 1A, 1B against the bias force of the spool returning spring 5. Therefore, the degree of the communication between the input port 7 and the output port 8 is increased, and at the same time, the degree of the communication between the output port 8 and the drain port 9 is decreased. At this time, a maximum output pressure is generated at the output port 8. At this time, the spool 4 stops at a position, at which a generated force, the bias force by the spool returning spring 5, and a feed back (F/B) force are balanced. Here, the generated force is applied to a right end face of the spool 4 in FIGS. 1A, 1B due to the internal pressure in the bleed chamber 34. The F/B force is generated when the maximum output pressure (input pressure to the F/B chamber 18) is applied to the F/B chamber 18. The stop position is set at a specific position, which is located at a right side of the maximum valve open position of the spool 4 (maximum lift position of the spool 4) in FIGS. 1A, 1B such that the spool 4 normally does not contact the step face 21a formed at the spring chamber 21.

When a drive current is supplied to the solenoid actuator 33 such that the open and close valve 32 is disengaged from the seat member 31 and the bleed port 35 is opened, the internal pressure in the bleed chamber 34 is reduced. As the drive current supplied to the solenoid actuator 33 increases, the lift of the open and close valve 32 increases. As a result, the internal pressure in the bleed chamber 34 is decreased such that the spool 4 is displaced rightward in FIGS. 1A, 1B. In other words, as the drive current supplied to the solenoid actuator 33 is increased, the degree of the communication between the input port 7 and the output port 8 is reduced, and the at the same time, the degree of the communication between the output port 8 and the drain port 9 is increased. Thus, the output pressure at the output port 8 is reduced.

When the drive current supplied to the solenoid actuator 33 is further increased such that the internal pressure in the bleed chamber 34 is equal to an exhaust pressure, the spool 4 contacts the seat member 31 and stops at the maximum valve closed position (spool seated position). The solenoid oil pressure control valve is normally structured such that the internal pressure in the bleed chamber 34 becomes equal to the exhaust pressure before the shaft end projection portion 48a contacts the adjustor end projection portion 49a. Like this, in a state where the spool 4 stops at the maximum valve closed position, the degree of the communication between the input port 7 and the output port 8 becomes the minimum (closed state) and at the same time, the degree of the communication between the output port 8 and the drain port 9 becomes the maximum so that the output pressure at the output port 8 becomes equal to the exhaust pressure.

Characteristics of the preferred embodiment will be described.

The seat member 31 includes a cylindrical portion 61, which internally forms the bleed chamber 34. An annular seat 62, which contacts the end portion of the spool 4 at all around the annular seat 62 (at an entire surface of the annular seat 62 facing the spool 4), is provided at a left end face of the cylindrical portion 61 in FIGS. 1A, 1B.

Then, when the spool 4 contacts the annular seat 62 of the seat member 31, the oil supply port 12, which introduces the oil into the bleed chamber 34, is blockaded such that the consumption flow rate of the oil, which is to be discharged, is reduced. Here, the oil travels through the oil supply port 12, the bleed chamber 34 and the bleed port 35 in this order to be drained.

A back ground of the preferred embodiment will be described.

Conventionally, when the spool 4 contacts the annular seat 62 and the oil supply port 12 is “completely blockaded” by the spool 4, supply of the oil into the bleed chamber 34 have been limited specially at the low temperature state, where the oil has a large viscosity.

Thus, a pilot communicating portion 63 is formed to provide communication between the oil supply port 12 and the bleed chamber 34 even when the spool 4 contacts the seat member 31.

The conventional pilot communicating portion 63 is an orifice 64 (a small groove formed at the annular seat 62) formed at a part of the annular seat 62 for connecting the oil supply port 12 and the bleed chamber 34. Thus, the conventional plot communicating portion 63 enables to provide communication between the oil supply port 12 and the bleed chamber 34 through the orifice 64 (see FIG. 4), even when the spool 4 contacts the annular seat 62.

Oil has a larger viscosity at the low temperature state and a smaller viscosity at the high temperature state.

Due to this property, when a passage area (cross-sectional area) of the orifice 64 is smaller at the low temperature state, the flow rate of the oil supplied to the bleed chamber 34 through the orifice 64 may become smaller. Thus, a responsibility of the spool 4 at a time, where the bleed port 35 is closed, may be degraded.

In contrast, when the passage area of the orifice 64 is larger at the high temperature state, the flow rate of the oil supplied to the bleed chamber 34 through the orifice 64 may become larger. Thus, the consumption flow rate of the oil at a time, where the spool 4 contacts the seat member 31, may become larger than needed.

From here, the description will return to the description of the present invention. To deal with the above disadvantage of the conventional art, there is provided a pilot communicating portion 63, which includes a slight clearance changing member 65, in the preferred embodiment. The slight clearance changing member 65 increases the degree of the communication between the oil supply port 12 and the bleed chamber 34 when the temperature is lowered. Also, when the temperature is increased, the slight clearance changing member 65 reduces the degree of the communication between the oil supply port 12 and the bleed chamber 34.

The slight clearance changing member 65 is formed at the annular seat (seat surface) 62, and includes a slit (pilot inlet port) 66 and a resin ring tube (thermal-expansion-and-contraction member) 67. The slit 66 provides communication between the oil supply port 12 and the bleed chamber 34 even when the spool 4 contacts (engages with) the seat member 31. The resin ring tube 67 contracts to open the slit 66 when the temperature is lowered. Also, the resin ring tube 67 expands to close the slit 66 when the temperature is increased.

Specifically, the slight clearance changing member 65 includes the slit 66 and the resin ring tube 67, which has a different coefficient of linear expansion. When the temperature is decreased, the resin ring tube 67 opens the slit 66 to increase the degree of the communication between the oil supply port 12 and the bleed chamber 34. Also, when the temperature is increased, the resin ring tube 67 closes the slit 66 to decrease the degree of the communication between the oil supply port 12 and the bleed chamber 34.

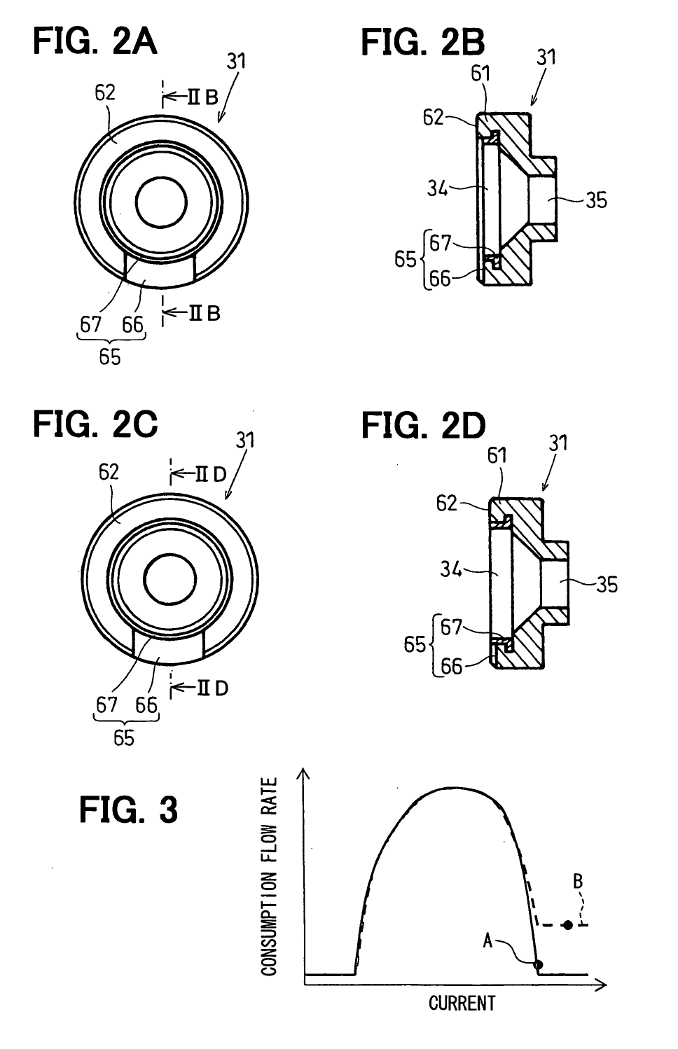

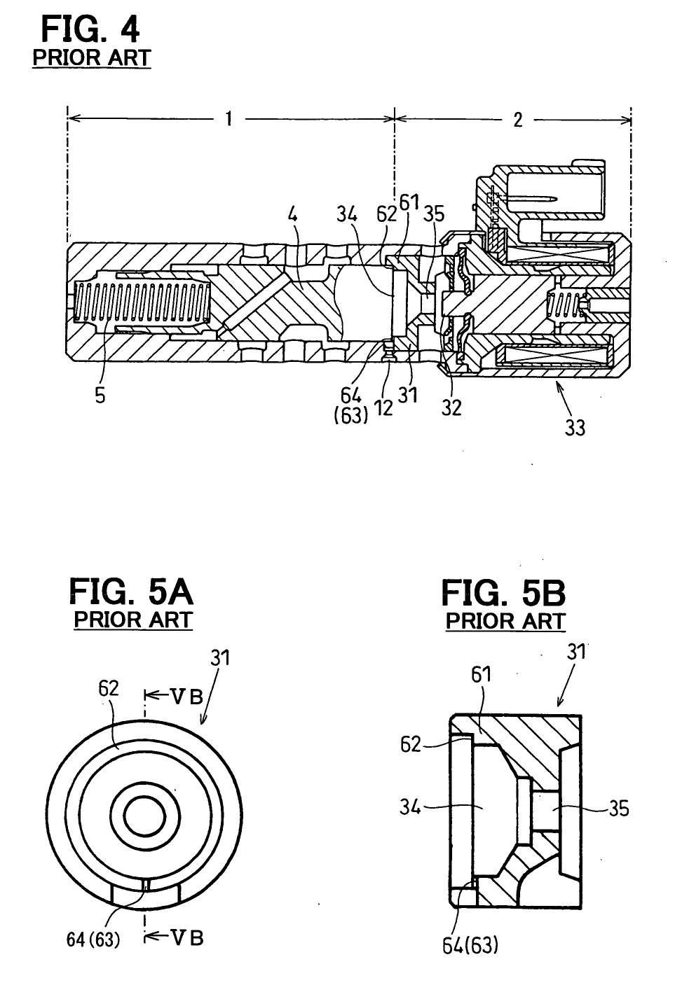

The slit 66 is a groove formed at the annular seat 62 and the groove has a wide width as shown in FIGS. 2A, 2C when seen along the longitudinal line of the seat member 31. The seat member 31, at which the slit is formed, is made of metal of a small coefficient of linear expansion (e.g., stainless steel, brass, copper).

The resin ring tube 67 is made of resin, such as polyphenylene sulfide (PPS), of a coefficient of linear expansion larger than that of the seat member 31. The resin ring tube 67 is fixed to an inner peripheral surface of the cylindrical portion 61 at a side (right side in FIGS. 1A, 1B) different from the annular seat 62 so that the resin ring tube 67 is fixed to the seat member 31. Also, the resin ring tube 67 has a tubular shape. Specifically, as shown in FIGS. 2B, 2D, the resin ring tube 67 includes a flange portion, which radially extends, at an end portion of the tube. This flange portion is engaged with an annular groove formed at the inner peripheral surface of the cylindrical portion 61 on the side different from the annular seat 62 such that the flange portion is assembled to the seat member 31.

At an expected minimum temperature state (e.g., a minimum temperature in cold climate areas), the resin ring tube 67 contracts in the longitudinal direction of the seat member 31 as shown in FIG. 2B such that the degree of the communication between the oil supply port 12 and the bleed chamber 34 through the slit 66 becomes maximum.

In contrast, at an expected maximum temperature state (e.g., a warming up temperature of the automatic transmission), the resin ring tube 67 expands in the longitudinal direction as shown in FIG. 2D such that the degree of the communication between the oil supply port 12 and the bleed chamber 34 through the slit 66 becomes minimum. Specifically, in the present embodiment, at the expected maximum temperature state, the resin ring tube 67 contacts the end portion of the spool 4, and the resin ring tube 67 blockades the slit 66.

It is noted that even when the resin ring tube 67 contacts the end portion of the spool 4 and blockades the slit 66 at the maximum temperature state, the oil is supplied into the bleed chamber 34. This is because the viscosity of the oil is small at the maximum temperature state such that the oil is supplied to the bleed chamber 34 through a slight clearance formed at the contact surface between the spool 4 and the resin ring tube 67

Advantage (effects) of the preferred embodiment will be described.

The pilot communicating portion 63 of the solenoid oil pressure control valve of the preferred embodiment includes the slight clearance changing member 65, which increases (decreases) the degree of the communication between the oil supply port 12 and the bleed chamber 34 when the temperature is decreased (increased). Here, the slight clearance changing member 65 changes the opening degree of the slit 66 formed at the seat member 31 using the resin ring tube 67, a length of which changes based on a change of the temperature.

Therefore, the solenoid oil pressure control valve of the preferred embodiment achieves the following advantages (effects).

Advantages at the low temperature state will be described.

At the low temperature state (i.e., when the temperature of the oil supplied to the oil supply port 12 is low), the resin ring tube 67 contracts in the longitudinal direction as shown in FIGS. 1A, 2B. As a result, the opening degree of the slit 66 provided at the seat member 31 becomes larger and the degree of the communication between the oil supply port 12 and the bleed chamber 34 becomes larger. Thus, even when the viscosity of the oil is large at the low temperature state, the flow rate (flow amount per unit time) of the oil supplied from the oil supply port 12 into the bleed chamber 34 through the slit 66 can be reliably attained. As a result, the responsibility of the spool 4 in a state, where the bleed port 35 is closed, can be improved.

Also, at the low temperature state, the flow rate of the oil supplied into the bleed chamber 34 can be substantially reduced even when the opening degree of the slit 66 is large. This is because the viscosity of the oil is large. Therefore, the consumption flow rate of the oil can be limited when the spool 4 contacts (engages with) the seat member 31.

Advantages at the high temperature state will be described.

At the high temperature state (i.e., when the temperature of the oil supplied to the oil supply port 12 is high), the resin ring tube 67 expands in the longitudinal direction as shown in FIGS. 1B, 2D. As a result, the opening degree of the slit 66 provided at the seat member 31 becomes smaller and the degree of the communication between the oil supply port 12 and the bleed chamber 34 becomes smaller. However, because the viscosity of the oil is small at the high temperature state, the flow rate of the oil supplied from the oil supply port 12 into the bleed chamber 34 through the slit 66 can be reliably attained, even when the opening degree of the slit 66 is small. As a result, the responsibility of the spool 4 in a state, where the bleed port 35 is closed, can be improved.

Also, at the high temperature state, the flow rate of the oil supplied into the bleed chamber 34 can be substantially reduced even though the viscosity of the oil is small. This is because the opening degree of the slit 66 is substantially small. Therefore, as shown in FIG. 3, the consumption flow rate of the oil in the present embodiment (shown as a solid line A) in a state, where the spool 4 contacts the seat member 31, can be reduced compared with that of the conventional art (shown as a dashed line B).

Thus, the solenoid oil pressure control valve of the preferred embodiment can optimize the degree of the communication between the oil supply port 12 and the bleed chamber 34 depending on the oil viscosity, which changes based on the temperature. In this way, the improved responsibility of the spool 4 and the reduced consumption flow rate of the oil can be both achieved.

Modifications of the above embodiment will be described.

In the above embodiment, at the high temperature state, the resin ring tube (thermal-expansion-and-contraction member) 67 expands to contact the spool (movable valve) 4 such that the slit (pilot inlet port) 66 is blockades. And then, the oil is supplied into the bleed chamber 34 through the slight clearance, which is provided at the contact surface between the resin ring tube 67 and the spool 4. However, a recess and a protrusion may be formed at the contact surface of either of the resin ring tube 67 and the spool 4 such that a slight clearance may be intentionally formed.

In the above embodiment, the present invention is applied to the normally open (N/O) solenoid oil pressure control valve. However, the present invention may be alternatively applied to a normally closed (N/C) solenoid oil pressure control valve.

In the above embodiment, the slight clearance changing member 65, which includes the slit 66 and the resin ring tube 67 in the preferred embodiment, is provided at the seat member 31. However, the slight clearance changing member 65 may be alternatively provided to the spool 4.

The above embodiment describes an example, in which the present invention is applied to the solenoid oil pressure control valve used in the oil pressure control apparatus for the automatic transmission. However, the present invention may be alternatively applicable to a solenoid oil pressure control valve used in other apparatus than the automatic transmission.

The above embodiment describes an example, in which the spool valve 1 structures the three-way valve. However, the spool valve 1 is not limited to the three-way valve, but may be alternatively a differently-structured spool valve, such as a two-way valve (open and close valve), a four-way valve.

The above embodiment describes an example, in which the present invention is applied for driving the spool valve 1 and the spool (movable valve) 4 is displaced in the longitudinal direction by the pressure in the bleed chamber 34. However, the movable valve is not limited to a valve, which is displaceable in the longitudinal direction. However, the present invention may be alternatively applicable to a main valve, which is displaceable in a rotation direction.

The above embodiment describes an example, in which the solenoid actuator 33 serves as one example of an electrically driven actuator for driving the open and close valve 32. However, other apparatus, such as an electric motor, a piezo actuator using a piezo stack, may alternatively serve as the electrically driven actuator.

Additional advantages and modifications will readily occur to those skilled in the art. The invention in its broader terms is therefore not limited to the specific details, representative apparatus, and illustrative examples shown and described.

What is claimed is:

1. A valve apparatus, comprising:
a valve body;
a seat member that is fixed to the valve body and defines a bleed chamber;
an oil supply port that supplies oil to the bleed chamber;
a movable valve that is slidably received in the valve body, wherein:
the movable valve is displaceable based on a pressure in the bleed chamber; and
the movable valve blockades the oil supply port in a state, where the movable valve contacts the seat member; and
a pilot communicating member that provides communication between the oil supply port and the bleed chamber in the state, where the movable valve contacts the seat member, wherein the pilot communicating member includes a slight clearance changing member that increases a degree of the communication when a temperature decreases, and decreases the degree of the communication when the temperature increases.

2. The valve apparatus according to claim 1, wherein:
the seat member includes a seat surface, through which the movable valve contacts the seat member such that the oil supply port is blockaded; and
the slight clearance changing member includes:
a pilot inlet port that is provided at the seat surface and provides the communication in the state, where the moving valve contacts the seat member; and
a thermal-expansion-and-contraction member that contracts to open the pilot inlet port when the temperature decreases, and expands to close the pilot inlet port when the temperature increases.

3. The valve apparatus according to claim 2, wherein:
the seat member includes:
a tubular portion that internally includes the bleed chamber; and
an annular seat that is located at an end face of the tubular portion to serve as the seat surface;
the pilot inlet port is formed at the annular seat;
the thermal-expansion-and-contraction member is a resin tube that is fixed to the seat member at an inner peripheral surface of the tubular portion on a side different from the annular seat; and
the resin tube contracts in a longitudinal direction of the resin tube to open the pilot inlet port when the temperature decreases, and expands in the longitudinal direction to close the pilot inlet port when the temperature increases.

4. The valve apparatus according to claim 1, wherein:
the valve body is a sleeve that has a generally tubular shape; and
the movable valve is a spool that is slidably received in the sleeve, slidable in a longitudinal direction of the sleeve.

5. The valve apparatus according to claim 3, wherein the annular seat contacts the movable valve through all around the annular seat in the state, where the movable valve contacts the seat member.
